(19) United States
(12) Patent Application Publication
(10) Pub. No.: US 2026/0239432 A1
(43) Pub. Date: Aug. 13, 2026

(54) RANDOM ACCESS RESPONSE WINDOW EXTENSION FOR SEQUENTIAL RANDOM ACCESS RESPONSE MESSAGES

(71) Applicant: QUALCOMM Incorporated, San Diego, CA (US)

(72) Inventors: Raviteja PATCHAVA, San Diego, CA (US); Jing SUN, San Diego, CA (US); Junyi LI, Greentown, PA (US); Jing JIANG, San Diego, CA (US)

(21) Appl. No.: 19/052,929

(22) Filed: Feb. 13, 2025

(51) Int. Cl. H04W 74/0833

(52) U.S. Cl. CPC H04W 74/0833

(57) ABSTRACT

Various aspects of the present disclosure generally relate to wireless communication. In some aspects, a user equipment (UE) may receive an indication of a random access response (RAR) window extension. The UE may transmit a first physical random access channel message that is based at least in part on a selected root sequence and a selected cyclic shift (CS) associated with the selected root sequence. The UE may receive, during an RAR window, a first RAR that is associated with the selected root sequence and a first CS that is different from the selected CS. The UE may perform, based at least in part on receiving the first RAR, an adjustment of the RAR window using the RAR window extension, resulting in an adjusted RAR window. The UE may communicate based at least in part on the adjusted RAR window. Numerous other aspects are described.

### FIELD OF THE DISCLOSURE

Aspects of the present disclosure generally relate to wireless communication and specifically relate to techniques, apparatuses, and methods associated with random access response window extension for sequential random access response messages.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication systems, a user equipment (UE) may establish a wireless connection with a network node using a random access procedure, such as a four-step random access procedure. In such examples, the network node may transmit one or more synchronization signal blocks or system information blocks, among other examples, that include random access configuration information. The random access configuration information may include one or more parameters to be used in the random access procedure, such as one or more parameters for transmitting a random access message (RAM) or one or more parameters for receiving a random access response (RAR). The UE may thus transmit an RAM (which may be referred to as a preamble or message 1) and may receive an RAR as a reply to the preamble (which may be referred to as message 2) that indicates a resource allocation to be used by the UE to transmit a radio resource control (RRC) connection request (which may be referred to as message 3). The UE may transmit the RRC connection request message (e.g., message 3) using the resources indicated by the RAR, and the network node may transmit, in response to receiving the RRC connection request, an RRC connection setup message.

### SUMMARY

Some aspects described herein relate to a method of wireless communication performed by a user equipment (UE). The method may include receiving an indication of a random access response (RAR) window extension. The method may include transmitting a first physical random access channel (PRACH) message that is based at least in part on a selected root sequence and a selected cyclic shift (CS) associated with the selected root sequence. The method may include receiving, during an RAR window, a first RAR that is associated with the selected root sequence and a first CS that is different from the selected CS. The method may include performing, based at least in part on receiving the first RAR, an adjustment of the RAR window using the RAR window extension, resulting in an adjusted RAR window. The method may include communicating based at least in part on the adjusted RAR window.

Some aspects described herein relate to a method of wireless communication performed by a network node. The method may include transmitting, to a UE, an indication of an RAR window extension. The method may include receiving, from the UE, a first PRACH message that is based at least in part on a selected root sequence and a selected CS associated with the selected root sequence. The method may include transmitting, to the UE during an RAR window, a first RAR that is associated with the selected root sequence and a first CS that is different from the selected CS, where an RAR window associated with the UE is adjusted using the RAR window extension, resulting in an adjusted RAR window, based at least in part on the first RAR being associated with the selected root sequence and the first CS. The method may include communicating, with the UE, based at least in part on the adjusted RAR window.

Some aspects described herein relate to a UE. The UE may include a processing system. The processing system may include one or more processors and one or more code-storing memories coupled with the one or more processors. The processing system may be configured to cause the UE to receive an indication of an RAR window extension. The processing system may be configured to cause the UE to transmit a first PRACH message that is based at least in part on a selected root sequence and a selected CS associated with the selected root sequence. The processing system may be configured to cause the UE to receive, during an RAR window, a first RAR that is associated with the selected root sequence and a first CS that is different from the selected CS. The processing system may be configured to cause the UE to perform, based at least in part on receiving the first RAR, an adjustment of the RAR window using the RAR window extension, resulting in an adjusted RAR window. The processing system may be configured to cause the UE to communicate based at least in part on the adjusted RAR window.

Some aspects described herein relate to a network node. The network node may include a processing system. The processing system may include one or more processors and one or more code-storing memories coupled with the one or more processors. The processing system may be configured to cause the network node to transmit, to a UE, an indication of an RAR window extension. The processing system may be configured to cause the network node to receive, from the UE, a first PRACH message that is based at least in part on a selected root sequence and a selected CS associated with the selected root sequence. The processing system may be configured to cause the network node to transmit, to the UE during an RAR window, a first RAR that is associated with the selected root sequence and a first CS that is different from the selected CS, where an RAR window associated with the UE is adjusted using the RAR window extension, resulting in an adjusted RAR window, based at least in part on the first RAR being associated with the selected root sequence and the first CS. The processing system may be configured to cause the network node to communicate, with the UE, based at least in part on the adjusted RAR window.

Some aspects described herein relate to a non-transitory computer-readable medium that stores a set of instructions for wireless communication by a UE. The set of instructions, when executed by one or more processors of the UE, may cause the UE to receive an indication of an RAR window extension. The set of instructions, when executed by one or more processors of the UE, may cause the UE to transmit a first PRACH message that is based at least in part on a selected root sequence and a selected CS associated with the selected root sequence. The set of instructions, when executed by one or more processors of the UE, may cause the UE to receive, during an RAR window, a first RAR that is associated with the selected root sequence and a first CS that is different from the selected CS. The set of instructions, when executed by one or more processors of the UE, may cause the UE to perform, based at least in part on receiving the first RAR, an adjustment of the RAR window using the RAR window extension, resulting in an adjusted RAR window. The set of instructions, when executed by one or more processors of the UE, may cause the UE to communicate based at least in part on the adjusted RAR window.

Some aspects described herein relate to a non-transitory computer-readable medium that stores a set of instructions for wireless communication by a network node. The set of instructions, when executed by one or more processors of the network node, may cause the network node to transmit, to a UE, an indication of an RAR window extension. The set of instructions, when executed by one or more processors of the network node, may cause the network node to receive, from the UE, a first PRACH message that is based at least in part on a selected root sequence and a selected CS associated with the selected root sequence. The set of instructions, when executed by one or more processors of the network node, may cause the network node to transmit, to the UE during an RAR window, a first RAR that is associated with the selected root sequence and a first CS that is different from the selected CS, where an RAR window associated with the UE is adjusted using the RAR window extension, resulting in an adjusted RAR window, based at least in part on the first RAR being associated with the selected root sequence and the first CS. The set of instructions, when executed by one or more processors of the network node, may cause the network node to communicate, with the UE, based at least in part on the adjusted RAR window.

Some aspects described herein relate to an apparatus for wireless communication. The apparatus may include means for receiving an indication of an RAR window extension. The apparatus may include means for transmitting a first PRACH message that is based at least in part on a selected root sequence and a selected CS associated with the selected root sequence. The apparatus may include means for receiving, during an RAR window, a first RAR that is associated with the selected root sequence and a first CS that is different from the selected CS. The apparatus may include means for performing, based at least in part on receiving the first RAR, an adjustment of the RAR window using the RAR window extension, resulting in an adjusted RAR window. The apparatus may include means for communicating based at least in part on the adjusted RAR window.

Some aspects described herein relate to an apparatus for wireless communication. The apparatus may include means for transmitting, to a UE, an indication of an RAR window extension. The apparatus may include means for receiving, from the UE, a first PRACH message that is based at least in part on a selected root sequence and a selected CS associated with the selected root sequence. The apparatus may include means for transmitting, to the UE during an RAR window, a first RAR that is associated with the selected root sequence and a first CS that is different from the selected CS, where an RAR window associated with the UE is adjusted using the RAR window extension, resulting in an adjusted RAR window, based at least in part on the first RAR being associated with the selected root sequence and the first CS. The apparatus may include means for communicating, with the UE, based at least in part on the adjusted RAR window.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIGS. 3A-3D are diagrams illustrating examples associated with a four-step random access procedure.

FIGS. 4A-4E are diagrams of examples associated with a random access response (RAR) window extension for sequential RAR messages.

FIG. 5 is a diagram illustrating an example process performed, for example, at a UE or an apparatus of a UE.

FIG. 6 is a diagram illustrating an example process performed, for example, at a network node or an apparatus of a network node.

FIG. 7 is a diagram of an example apparatus for wireless communication.

FIG. 8 is a diagram of another example apparatus for wireless communication.

### DETAILED DESCRIPTION

In some wireless communication systems, a network node and a user equipment (UE) may communicate with one another to perform a four-step random access procedure, sometimes referred to herein as a random access channel (RACH) procedure. In such examples, the UE may transmit a random access message (RAM), which may include a preamble or which may be referred to as message 1 (msg1). The network node may transmit a random access response (RAR) as a reply to the preamble, which may be referred to as message 2 (msg2). The RAR may indicate the detected random access preamble identifier (e.g., received from the UE in msg1) or a resource allocation to be used by the UE to transmit the next message (sometimes referred to as message 3 (msg3)). The UE may thus transmit msg3 using the resources allocated by msg2, which may be a radio resource control (RRC) connection request message. In response, the network node may transmit an RRC connection setup message, sometimes referred to herein as message 4 (msg4). In some examples, the RACH procedure described above may be associated with an RAR window, which may be a specific time period during which the UE expects to receive an RAR (e.g., msg2) from the network node after transmitting a preamble (e.g., msg1). In some examples, if the UE 120 does not receive an RAR within the RAR window, the UE may retry the RACH procedure, such as by transmitting another preamble, among other examples.

In some examples, multiple UEs may transmit one or more of the messages of the RACH procedure described above, which may cause a collision at the network node. For example, in cases in which multiple UEs select the same preamble (e.g., the same root sequence and same cyclic shift (CS) associated with the root sequence) for msg1, there may be a collision in the msg3 transmissions, resulting in one or more of the UEs needing to retransmit msg1 in a subsequent RACH occasion (RO). In order to avoid colliding RACH messages at the network node, the network node may trigger (using a message sometimes referred to as message X (msgX)) an additional physical random access channel (PRACH) transmission (sometimes referred to as message Y (msgY)). Additionally, or alternatively, to improve multi-path detection associated with certain RACH procedures, a network node may implement an over-provisioned CS scheme, in which the UEs may be configured to select from a higher quantity of CSs per root sequence than in traditional RACH procedures. In such cases, because a quantity of CSs associated with each root sequence is higher than for traditional RACH procedures, there may be a reduced chance of msg1 collisions at the network node. However, the network node may need to utilize sequential RAR transmissions (e.g., sequential transmissions of msg2) in over-provisioned CS schemes, such as for a purpose of collision resolution at the network node for preambles in which the respective CSs are relatively close to one another.

Moreover, in examples involving msgX/msgY transmissions or sequential RAR transmissions, a UE may receive an RAR later in time than the UE would typically receive an RAR for traditional RACH procedures. In such examples, the UE's RAR window may expire prior to the UE receiving an RAR directed to that UE. In such examples, the UE may need to transmit a subsequent preamble (e.g., msg1), such as in a subsequent RO. This may result in increased latency associated with RACH procedures, among other examples. On the other hand, if the network node were to configure all UEs with longer default RAR windows to accommodate for the msgX/msgY transmissions or sequential RAR transmissions, the longer default RAR windows may result in high power consumption and increased delay, as certain UEs may operate with unnecessarily long RAR windows.

Various aspects relate generally to improved RAR monitoring for UEs. Some aspects more specifically relate to an RAR window extension to be implemented at a UE, such as for a purpose of extending an RAR window when the UE is monitoring for a sequential RAR transmission (e.g., a sequential msg2 transmission, among other examples). In some aspects, a network node may transmit, and a UE may receive, an indication of an RAR window extension. The UE may transmit a PRACH message (e.g., a preamble or msg1) that is based at least in part on a selected root sequence and a selected CS associated with the selected root sequence. The UE may receive, during an RAR window, a first RAR (e.g., a first msg2) that is associated with the selected root sequence but that is associated with a CS that is different from the CS transmitted by the UE (used by the UE for the preamble). Accordingly, based at least in part on receiving the first RAR, the UE may adjust the RAR window using the RAR window extension, such as for a purpose of continuing to monitor for a sequential RAR (e.g., a sequential msg2 associated with the CS transmitted by the UE). In some aspects, the UE may adjust the RAR window using the RAR window extension based at least in part on detecting that a CS associated with an RAR that is received during the initial RAR window is within a CS threshold of a CS selected by the UE for the PRACH message. Additionally, or alternatively, the RAR window extension may be received from the network node via RRC signaling; in some other aspects, the RAR window extension may be dynamically signaled to the UE, such as via the RAR that is received during the initial RAR window and that is associated with a CS that differs from the CS transmitted by the UE.

Particular aspects of the subject matter described in this disclosure can be implemented to realize one or more of the following potential advantages. In some examples, the described techniques can be used to perform RACH procedures with reduced latency, as compared to RACH procedures in which the UE transmits additional preamble messages (e.g., msg1s) in response to a default RAR window elapsing prior to the UE receiving a sequential RAR. Additionally, or alternatively, the described techniques can be used by the network node and the UE to communicate with reduced power, computing, or network resource consumption as compared to RACH procedures in which the UE transmits additional preamble messages (e.g., msg1s) in response to a default RAR window elapsing. Moreover, the described techniques can be used by the network node and UEs to collectively reduce power consumption as compared to examples in which the UEs are all configured with a relatively long default RAR window to accommodate for msgX/msgY transmissions or sequential RAR transmissions.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

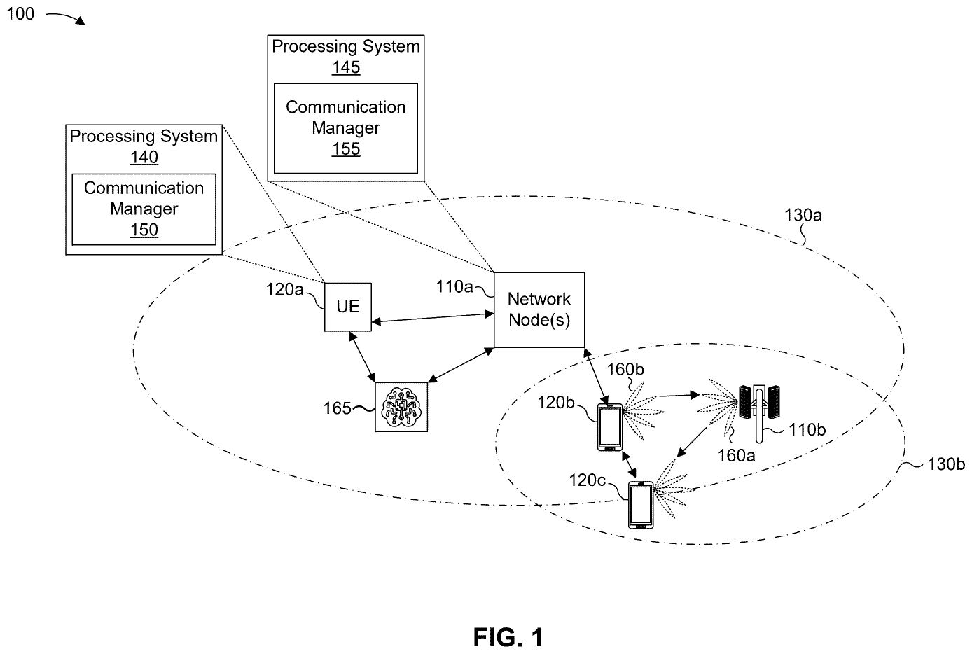

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive an indication of an RAR window extension; transmit a first PRACH message that is based at least in part on a selected root sequence and a selected CS associated with the selected root sequence; receive, during an RAR window, a first RAR that is associated with the selected root sequence and a first CS that is different from the selected CS; perform, based at least in part on receiving the first RAR, an adjustment of the RAR window using the RAR window extension, resulting in an adjusted RAR window; and communicate based at least in part on the adjusted RAR window. Additionally, or alternatively, the communication manager 150 may perform one or more other operations described herein.

In some aspects, the network node 110 may include a communication manager 155. As described in more detail elsewhere herein, the communication manager 155 may transmit, to a UE, an indication of an RAR window extension; receive, from the UE, a first PRACH message that is based at least in part on a selected root sequence and a selected CS associated with the selected root sequence; transmit, to the UE during an RAR window, a first RAR that is associated with the selected root sequence and a first CS that is different from the selected CS, wherein an RAR window associated with the UE is adjusted using the RAR window extension, resulting in an adjusted RAR window, based at least in part on the first RAR being associated with the selected root sequence and the first CS; and communicate, with the UE, based at least in part on the adjusted RAR window. Additionally, or alternatively, the communication manager 155 may perform one or more other operations described herein.

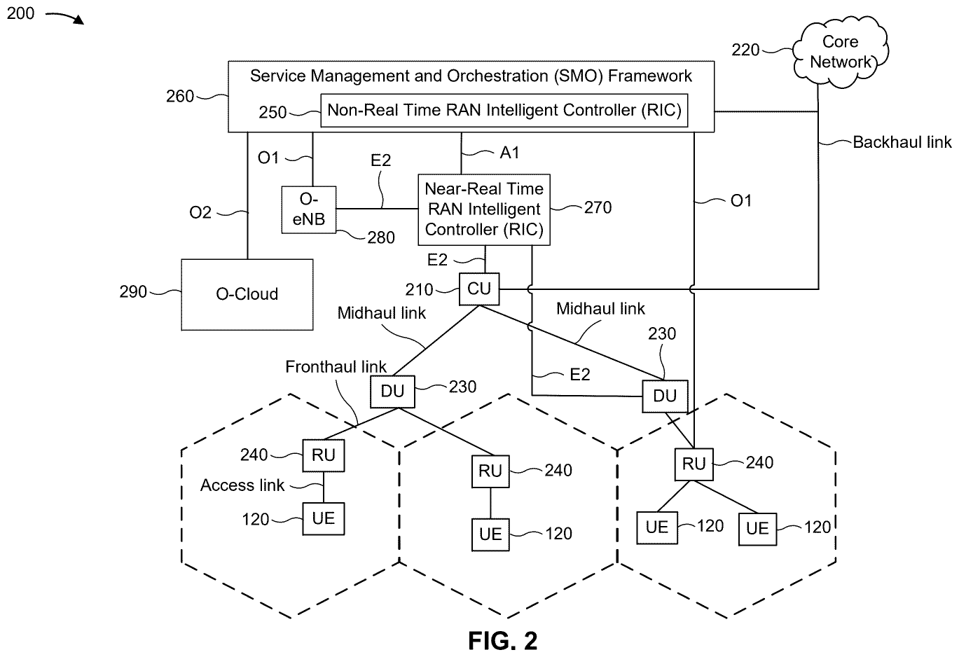

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

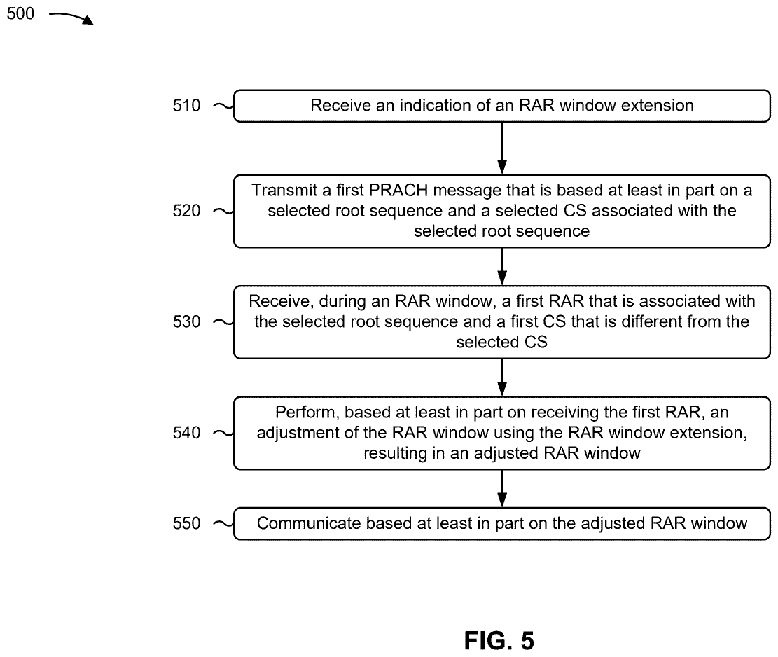

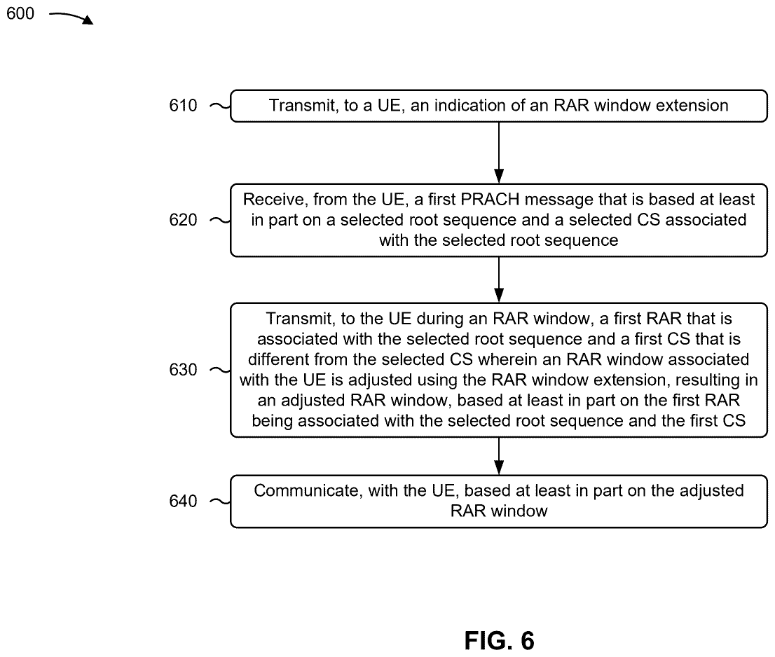

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with an RAR window extension for sequential RAR messages, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, or interpreting the instructions, among other examples.

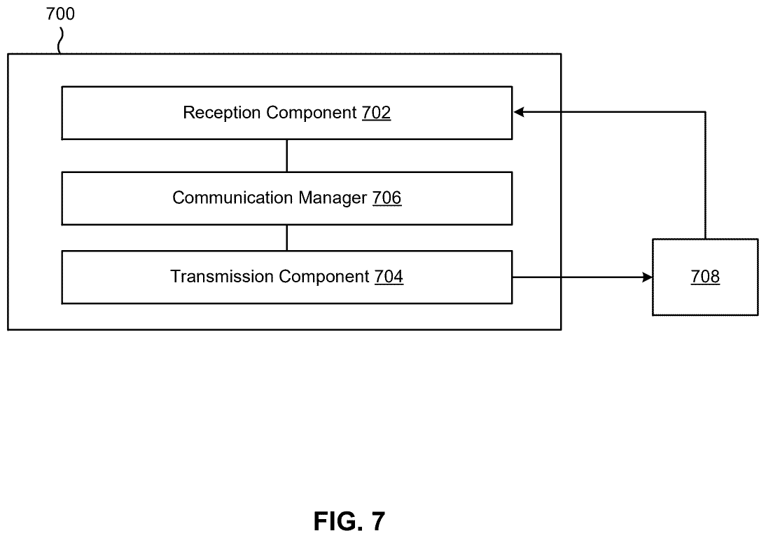

In some aspects, the UE 120 includes means for receiving an indication of an RAR window extension; means for transmitting a first PRACH message that is based at least in part on a selected root sequence and a selected CS associated with the selected root sequence; means for receiving, during an RAR window, a first RAR that is associated with the selected root sequence and a first CS that is different from the selected CS; means for performing, based at least in part on receiving the first RAR, an adjustment of the RAR window using the RAR window extension, resulting in an adjusted RAR window; or means for communicating based at least in part on the adjusted RAR window. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

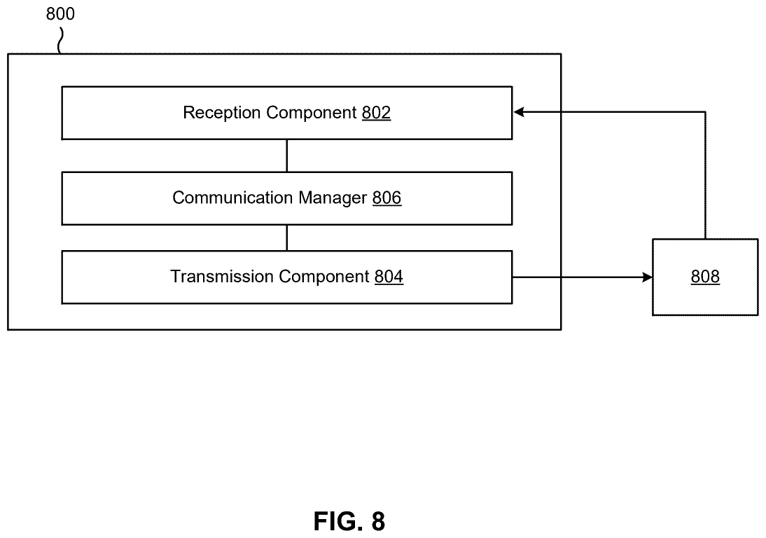

In some aspects, the network node 110 includes means for transmitting, to a UE, an indication of an RAR window extension; means for receiving, from the UE, a first PRACH message that is based at least in part on a selected root sequence and a selected CS associated with the selected root sequence; means for transmitting, to the UE during an RAR window, a first RAR that is associated with the selected root sequence and a first CS that is different from the selected CS, wherein an RAR window associated with the UE is adjusted using the RAR window extension, resulting in an adjusted RAR window, based at least in part on the first RAR being associated with the selected root sequence and the first CS; or means for communicating, with the UE, based at least in part on the adjusted RAR window. The means for the network node 110 to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

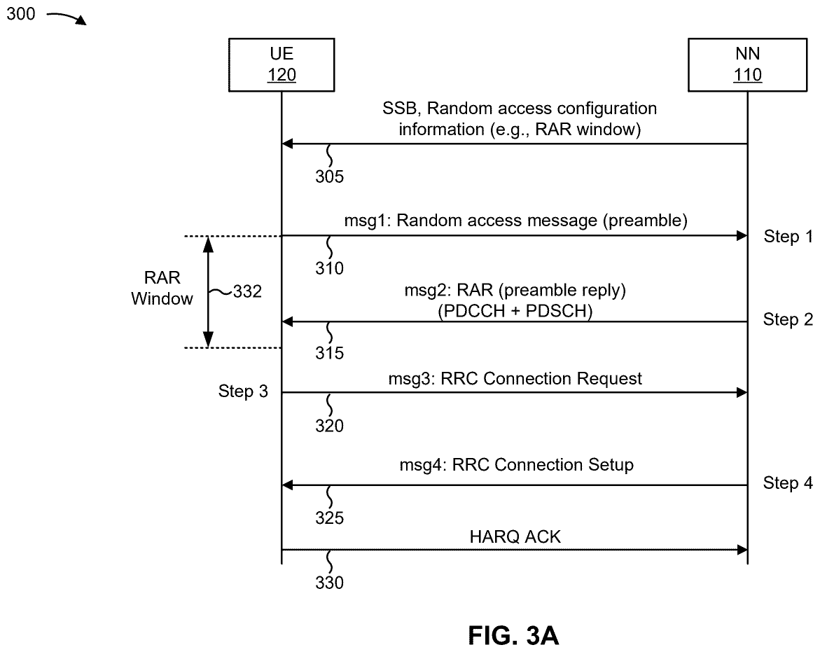

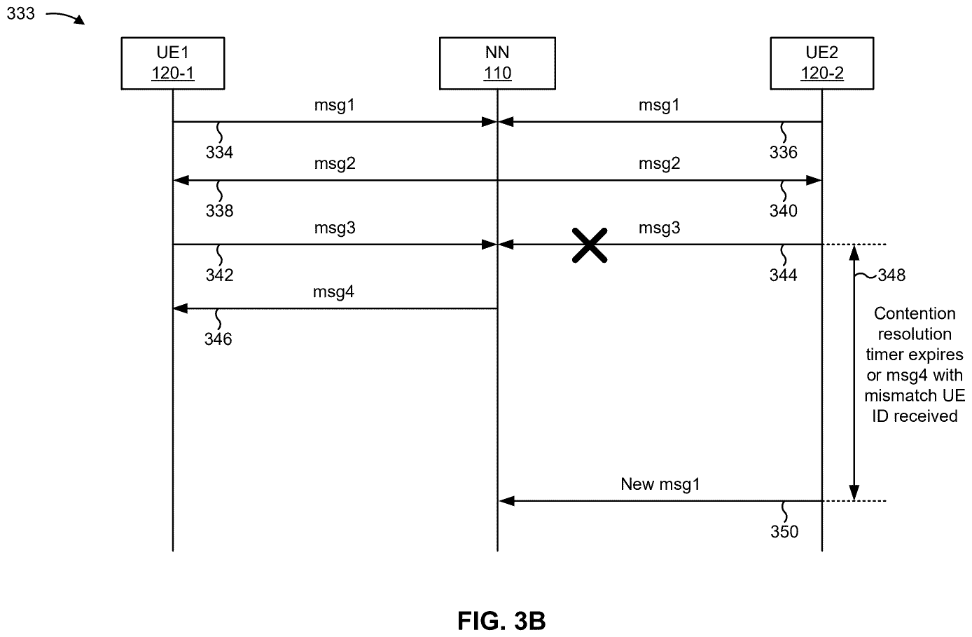

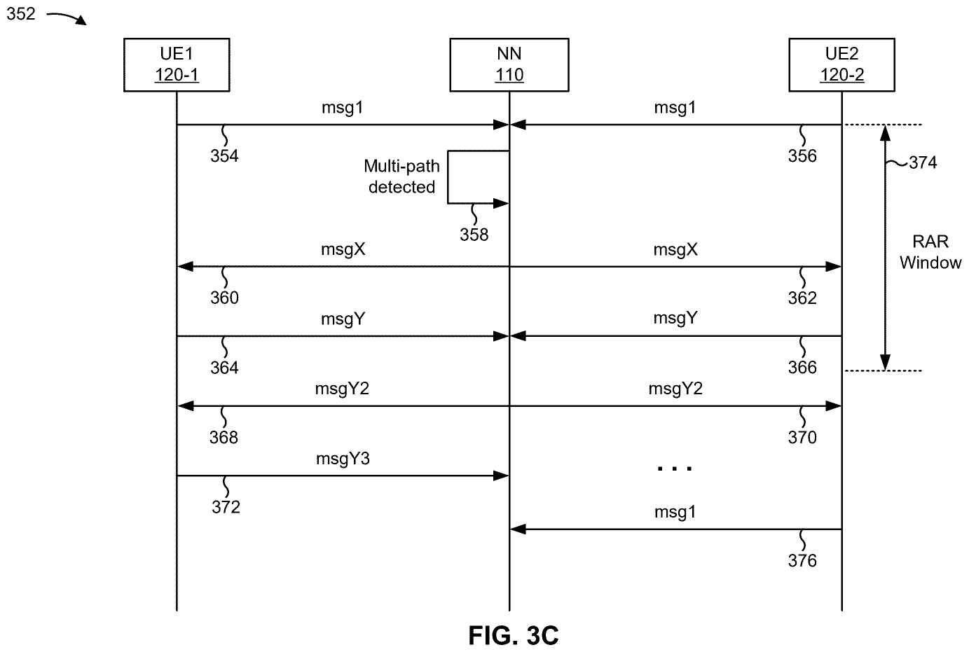

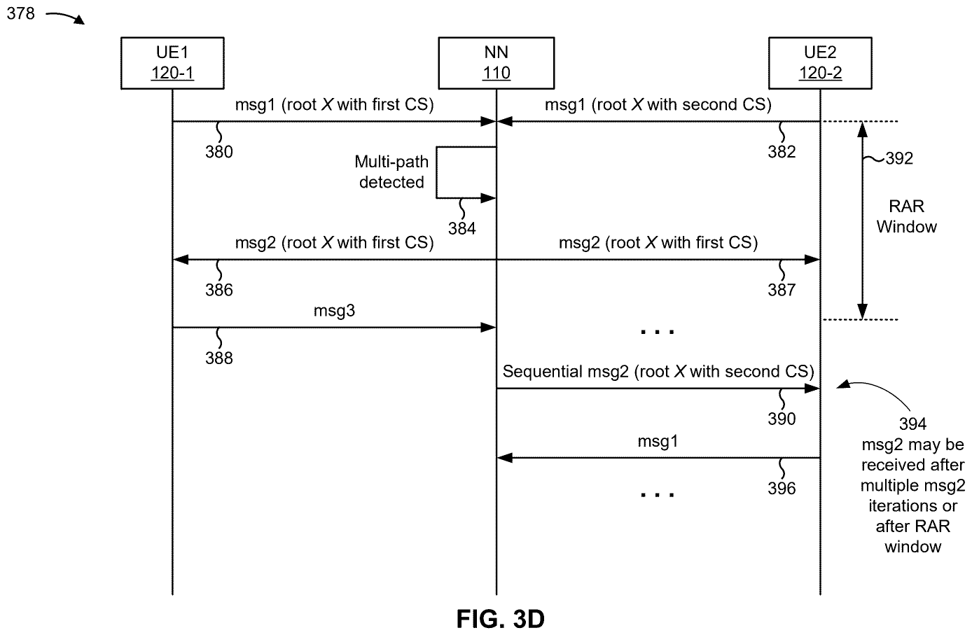

FIGS. 3A-3D are diagrams illustrating examples associated with a four-step random access procedure. As shown in FIG. 3A, and by example 300, a network node 110 and a UE 120 may communicate with one another to perform the four-step random access procedure.

As shown by reference number 305, the network node 110 may transmit, and the UE 120 may receive, one or more SSBs and random access configuration information. In some examples, the random access configuration information may be transmitted in or indicated by system information (e.g., in one or more system information blocks (SIBs)) or an SSB, such as for contention-based random access. Additionally, or alternatively, the random access configuration information may be transmitted in an RRC message or a PDCCH order message that triggers a RACH procedure, such as for contention-free random access. The random access configuration information may include one or more parameters to be used in the random access procedure, such as one or more parameters for transmitting a RAM or one or more parameters for receiving an RAR.

As shown by reference number 310, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, an initial message in a four-step random access procedure. The random access message may include a random access preamble identifier.

As shown by reference number 315, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some examples, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 320, the UE 120 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (e.g., an RRC connection request).

As shown by reference number 325, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by reference number 330, if the UE 120 successfully receives the RRC connection setup message, the UE 120 may transmit a HARQ ACK.

In some examples, the random access configuration information described above in connection with reference number 305 may indicate an RAR window 332 associated with the four-step RACH procedure, such as via a random access response window information element (IE) (sometimes referred to herein as ra-ResponseWindow), among other examples. The RAR window 332 may be a specific time period during which the UE 120 expects to receive an RAR (e.g., msg2) from the network node 110 after transmitting a preamble (e.g., msg1). In some examples, if the UE 120 does not receive an RAR within the RAR window 332, the UE 120 may retry the RACH procedure, such as by transmitting another preamble (e.g., another msg1), among other examples. In some examples, an RAR window size may be configured by the network node 110 (such as via the RAR configuration information described above in connection with reference number 305) or may be expressed in a quantity of subframes (e.g., in a range of 2 to 10 subframes, among other examples). Additionally, or alternatively, although shown in example 300 as beginning at a same time as a transmission of the preamble, in some other examples the RAR window 332 may begin a specific time transmission interval (TTI) after transmission of the preamble, among other examples.

In some examples, such as example 333 shown in FIG. 3B, multiple UEs may transmit one or more of the messages shown and described above in connection with FIG. 3A, which may cause a collision at the network node 110. For example, as shown in FIG. 3B, a first UE 120-1 and a second UE 120-2 may both transmit msg1 (as indicated by reference numbers 334 and 336, respectively), which may simultaneously be received at the network node 110. More particularly, each UE 120-1, 120-2 may randomly pick a preamble (e.g., a root sequence and an associated CS) and transmit msg1, which may collide at the network node 110. In such examples, the network node 110 may detect paths coming from multiple UEs, and thus may transmit msg2 for each detected preamble (as indicated by reference numbers 338 and 340, respectively) allocating resources for msg3 transmissions. In examples in which the UEs 120-1, 120-2 select the same preamble for msg1, there may be a collision in the msg3 transmissions, and thus one or more of the UEs 120-1, 120-2 may need to retransmit msg1 in the next RO. For example, as shown in example 333, msg3 from the first UE 120-1 (indicated by reference number 342) may collide with msg3 from the second UE 120-2 (indicated by reference number 344). Accordingly, the network node 110 may safely receive or detect the msg3 from only one UE, such as the first UE 120-1 in example 333 (shown by crossing out the msg3 transmission originating from the second UE 120-2 shown in connection with reference number 344). Accordingly, the network node 110 may transmit msg4 to the first UE 120-1 (as indicated by reference number 346) but may refrain from transmitting msg4 to the second UE 120-2. In this regard, after a contention resolution timer expires at the second UE 120-2 or after a msg4 with a mismatch UE identifier (ID) is received by the second UE 120-2 (as indicated by reference number 348), the UE 120-1 may reattempt the RACH procedure, such as by transmitting another msg1 in the next PRACH interval (as indicated by reference number 350).

In some aspects, the network node 110 may trigger additional PRACH transmissions for contention resolution or to avoid collisions in msg3 transmissions. For example, as shown in FIG. 3C, and by example 352, the first UE 120-1 and the second UE 120-2 may transmit msg1 (as indicated by reference numbers 354 and 356, respectively), which may be received at the network node 110 in a similar manner as described above in connection with reference numbers 334 and 336. As indicated by reference number 358, the network node 110 may detect a collision in the msg1 transmissions, such as by using a multi-path (in the time domain) detection procedure. For example, the network node 110 may be able to successfully detect multiple paths in large cells in which near and far UEs select the same root sequence and CS for msg1 but the two msg1 transmissions arrive at the network node 110 at different or separable timings, due to the difference in propagation delay for the two UEs. In such examples, the network node 110 may, in the operations indicated by reference number 358, assume that the detected multiple paths for the same root sequence and CS are coming from different UEs, and thus may attempt to perform a collision resolution procedure by triggering additional PRACH messages.

More particularly, the network node 110 may transmit a message (sometimes referred to herein as message X or msgX) allocating resources for additional PRACH transmissions (sometimes referred to herein as message Y or msgY). That is, as indicated by reference numbers 360 and 362, the network node 110 may transmit a msgX that is received by the first UE 120-1 and the second UE 120-2, respectively, and that indicates resources to be used by the UEs 120-1, 120-2 for performing msgY transmissions (e.g., additional PRACH transmissions). The UEs 120-1, 120-2 may thus randomly select a preamble (e.g., a root sequence and CS) and transmit respective msgYs (shown in connection with reference numbers 364 and 366) for collision resolution using the resources indicated by msgX. In response, and as indicated by reference numbers 368 and 370, the network node 110 may transmit respective RARs (sometimes referred to herein as message Y2, or msgY2, to indicate that the RAR is in response to a msgY transmission), which may be substantially similar to msg2 described above. Accordingly, one or more of the UEs 120-1, 120-2 may respond with a message (sometimes referred to herein as message Y3, or msgY3, to indicate that the message is in response to a msgY2 transmission), which may be substantially similar to msg3 described above and/or which may be an RRC connection request message. For example, as indicated by reference number 372, the first UE 120-1 may transmit msgY3 to the network node 110.

However, in some examples, the additional messages shown and described in connection with reference number 352 may result in an RAR being received by certain UEs after expiration of an RAR window, such as RAR window 374 shown in connection with the second UE 120-2. More particularly, in this example the msgY2 shown in connection with reference number 370 may arrive at the second UE 120-2 after the RAR window 374 has expired. Accordingly, notwithstanding that the collisions may have been successfully resolved at the network node 110, the second UE 120-2 may need to begin the RACH procedure anew, such as by retransmitting msg1 in a subsequent RO, as indicated by reference number 376.

Moreover, using a multi-path detection procedure for identifying collisions at the network node 110 (e.g., the multi-path detection procedure described above in connection with reference number 358) may work well in examples involving large cells or cells with a uniform distribution of round trip times (RTT), such that received paths from multiple users that transmit using the same CS arrive at the network node 110 at different CSs (e.g., due to channel randomness, among other examples). However, in examples involving small cells, large cells with many UEs present in a small area, or similar conditions in which there may not be a significant separation between RTTs of the various UEs within the cell, the network node 110 may only detect a single path for UEs selecting the same preamble (e.g., the same root sequence and CS).

Accordingly, to improve multi-path detection or otherwise reduce improve RACH procedures, a network node 110 may provide an over-provisioned CS configuration to the UEs 120-1, 120-2, sometimes referred to herein as implementing an over-provisioned CS scheme. In over-provisioned CS schemes, the UEs 120-1, 120-2 may be configured to select from a higher quantity of CSs per root sequence than in traditional RACH procedures, with a difference between CSs being smaller than a maximum RTT associated with the UEs in the cell. In such cases, because a quantity of CSs associated with each root sequence is higher than for traditional RACH procedures, there may be a reduced chance of msg1 collisions at the network node 110.

However, for an over-provisioned CS scheme or a similar RACH procedure, the network node 110 may have difficulty finding timing for a particular UE or difficulty identifying collisions between multiple UEs because the difference between transmitted CSs is smaller than a maximum RTT for the cell. For a timing advance computation, one solution may be for the network node 110 to transmit the absolute CS for the detected path, and the UE 120 may compute timing by subtracting the transmitted CS from the detected path CS. However, for determining a collision at the network node 110, a traditional approach of declaring the collision if the detected paths are separated by less than a maximum RTT may not work. This is because there may be cases where the detected paths at network node 110 are within the maximum RTT (and thus the network node 110 may not accurately estimate the collision) but at least some of the UEs 120 may be able to find the accurate timing. Put another way, because a UE 120 has more information than the network node 110 in such instances (e.g., because the UE 120 is aware of the transmitted CS), the UE 120 may identify which detected path corresponds to itself even when the network node 110 may see a collision at the network node 110 side.

For example, as shown in FIG. 3D, and by example 378, the first UE 120-1 and the second UE 120-2 may transmit msg1s (shown by reference numbers 380 and 382, respectively) using a selected root sequence and a selected CS (e.g., a selected one of the over-provisioned CSs). In this example, the first UE 120-1 and the second UE 120-2 select the same root sequence (referred to as root X in example 378) but different CSs (referred to as a first CS and a second CS in example 378). As indicated by reference number 384, the network node 110 may detect two paths corresponding to the first UE 120-1 and the UE 120-2, with a delay difference of less than a maximum RTT, but may not be able to determine which path belongs to which UE. From the UE perspective, for any of the UEs 120-1, 120-2 for which there is only one path detected within a maximum RTT from that UE's transmission, the UE can accurately detect the timing. On the other hand, for any of the UEs 120-1, 120-2 for which there are two paths detected within the maximum RTT from that UE's transmission, the UE 120 may require a msgY transmission or similar transmission for accurate timing detection. In this regard, in some examples the network node 110 may detect a collision, but certain UEs 120 may not see a collision.

Accordingly, to perform collision resolution in such examples or to otherwise improve a PRACH access delay in such examples, the network node 110 may utilize sequential RAR (e.g., msg2) transmissions. Put another way, the network node 110 may transmit msg2s sequentially for a group of detected paths with a collision at the network node 110 (e.g., a group of paths detected by the network node 110 via the operations described above in connection with reference number 384). In such examples, the network node 110 may divide the detected paths into multiple groups based on certain conditions (e.g., for each detected path within a group, there is at least one other detected path within a maximum RTT, or all other detected paths outside the group are separated by at least a maximum RTT from all the paths in the group). In such examples, for each group of detected paths, the network node 110 may initially transmit a msg2 corresponding to one detected path, and based on receiving a msg3 for that path, the network node 110 may proceed with transmitting a msg2 for the next detected path, and so forth for all of the detected paths in a group. After receiving msg3s from all of the detected paths, the network node 110 may optionally transmit msgX to resolve any remaining collisions.

Returning to the example 378, upon detecting a collision associated with the first UE 120-1's msg1 (e.g., the preamble associated with root X and the first CS) and the second UE 120-2's msg1 (e.g., the preamble associated with root X and the second CS), the network node may transmit, and the first UE 120-1 and the second UE 120-2 may receive (shown by reference numbers 386 and 387, respectively), a msg2 associated with a first of the detected paths (e.g., the path associated with the first UE 120-1 or the first CS). As indicated by reference number 388, the first UE 120-1 may identify that the msg2 is directed to the first UE 120-1 and thus may transmit msg3 using resources indicated by the msg2. Based at least in part on receiving the msg3 response for the first path, the network node 110 may transmit a sequential msg2 for a second of the detected paths (e.g., the path associated with the second UE 120-2 or the second CS), as indicated by reference number 390. In such examples, the sequential msg2 may help the network node 110 to resolve the UE paths that are in collision. For example, the network node 110 may use the msg2 described above in connection with reference number 386 (and the first UE 120-1's response thereto) to map the first detected path to the first UE 120-1, and may use the sequential msg2 described above in connection with reference number 390 (and the second UE 120-2's response thereto) to map the second detected path to the second UE 120-2.

However, in some examples, such as examples involving sequential transmission of msg2s in over-provisioned CS schemes, some UEs may receive a corresponding msg2 after a few msg2 iterations (e.g., after one or more other msg2s have been transmitted to other UEs, in a group of UEs). Accordingly, a certain UE's RAR window (e.g., ra-ResponseWindow) may expire prior to the UE receiving a sequential msg2 directed to that UE. For example, as shown in FIG. 3D, the second UE 120-2 may be associated with an RAR window 392, and the sequential msg2 that is directed to the second UE 120-2 (e.g., the sequential msg2 that is associated with root X and the second CS) may be transmitted after the RAR window 392 has expired, as indicated by reference number 394. In such aspects, the second UE 120-2 may need to retransmit msg1 in a subsequent RO, as indicated by reference number 396. This may result in increased latency and power, computing, and network resource consumption associated with RACH operations, among other examples. On the other hand, configuring the UEs 120-1, 120-2 with longer default RAR windows, such as for a purpose of enabling the UEs 120-1, 120-2 to monitor for sequential RARs, may result in unnecessarily long RAR windows for certain UEs and thus increased power consumption and delay for the devices as a whole.

Some aspects and techniques described herein enable improved RACH procedures, such as improved RACH procedures in examples involving over-provisioned CS schemes. For example, some aspects and techniques described herein enable implementation of an RAR window extension at a UE, such as for a purpose of extending an RAR window to monitor for a sequential RAR transmission (e.g., a sequential msg2 transmission as described above in connection with FIG. 3D, among other examples). In some aspects, a network node may transmit, and a UE may receive, an indication of an RAR window extension. Moreover, the UE may transmit a PRACH message (e.g., a preamble or msg1) that is based at least in part on a selected root sequence and a selected CS associated with the selected root sequence. The UE may receive, during an RAR window, a first RAR (e.g., msg2) that is associated with the selected root sequence and a first CS that is different from the selected CS. Based at least in part on receiving the first RAR, the UE may adjust the RAR window using the RAR window extension, resulting in an adjusted RAR window, such as for a purpose of continuing to monitor for a sequential RAR (e.g., a sequential msg2).

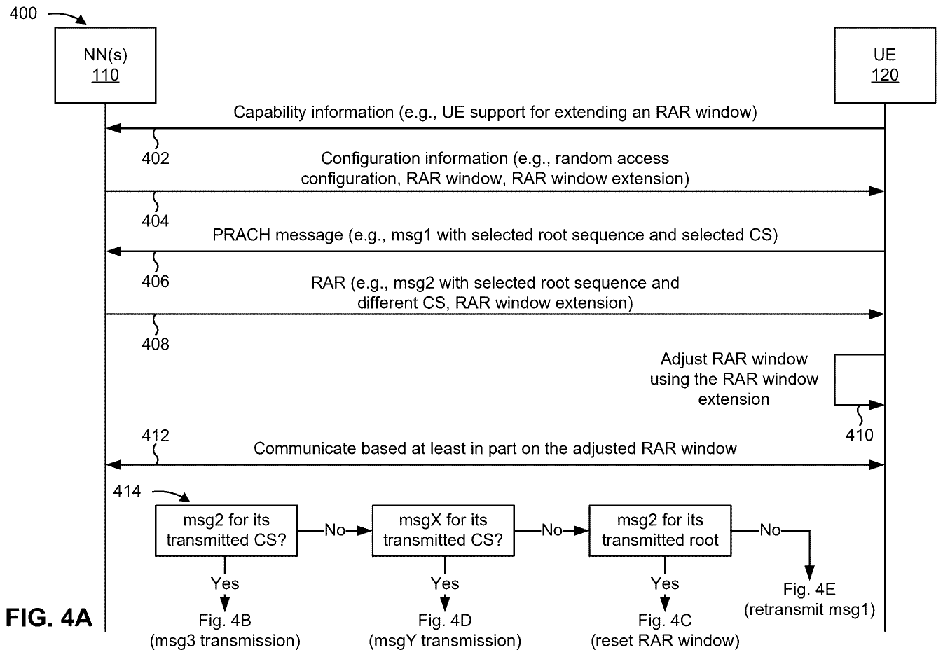

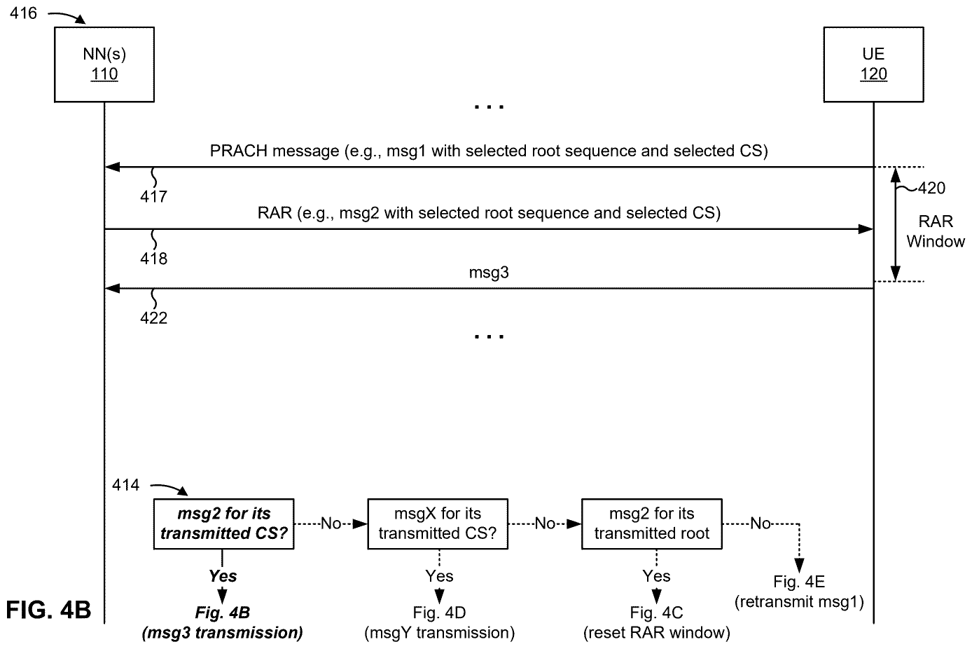

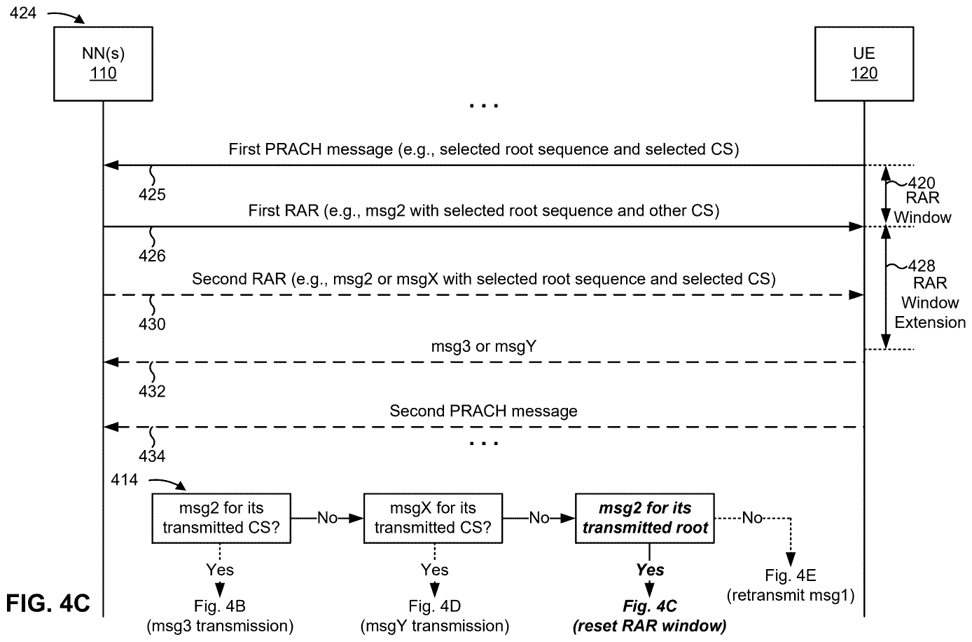

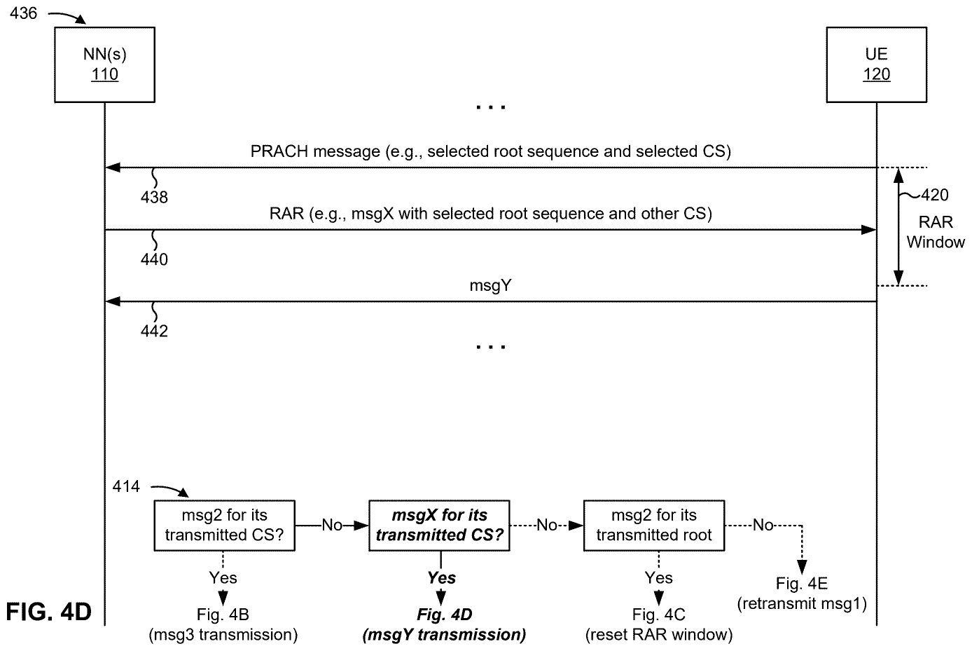

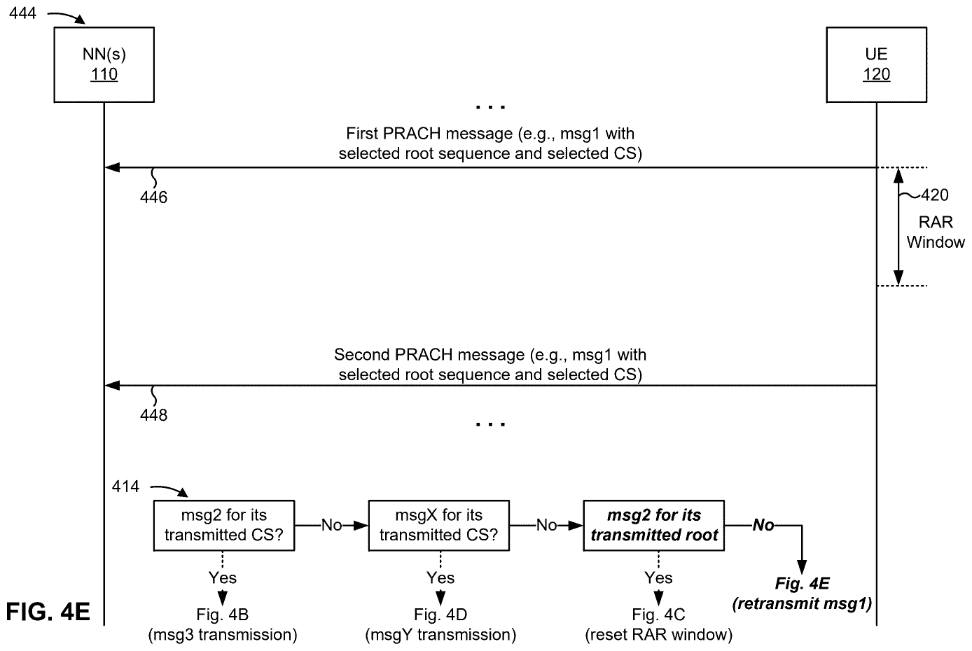

As a result, the UE and the network node may perform RACH procedures with reduced latency, as compared to RACH procedures in which the UE transmits additional preamble messages in response to a default RAR window elapsing. Additionally, or alternatively, the network node and the UE may communicate with reduced power, computing, or network resource consumption, as compared to RACH procedures in which the UE transmits additional preamble messages (e.g., msg1s) in response to a default RAR window elapsing and/or in which a long default RAR window is utilized to accommodate sequential RARs. Aspects of extending an RAR window are described in more detail below in connection with FIGS. 4A-4E.

As indicated above, FIGS. 3A-3D are provided as examples. Other examples may differ from what is described with regard to FIGS. 3A-3D.

FIGS. 4A-4E are diagrams of examples associated with an RAR window extension for sequential RAR messages. As shown in FIGS. 4A-4E, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIGS. 4A-4E.

As shown in FIG. 4A, and by example 400, in some aspects the UE 120 may transmit capability information (as indicated by reference number 402). The capability information may be included in a capability report. The UE 120 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a physical sidelink control channel (PSCCH), or a physical sidelink shared channel (PSSCH), among other examples. The capability information may indicate one or more parameters associated with respective capabilities of the UE 120. The one or more parameters may be indicated via respective IEs included in a capability report.

The capability information may indicate whether the UE 120 supports a feature or one or more parameters related to the feature. For example, the capability information may indicate a capability or parameter for receiving sequential RARs, such as sequential RARs associated with an over-provisioned CS scheme, among other examples. As another example, the capability information may indicate a capability or parameter for extending an RAR window associated with a RACH procedure, such as for a purpose of receiving sequential RARs, among other examples. One or more operations described herein may be based on capability information. For example, the UE 120 may perform a communication in accordance with the capability information, or may receive configuration information that is in accordance with the capability information. In some aspects, the capability information may indicate UE support for receiving an indication of an RAR window extension or adjusting an RAR window using the RAR window extension based at least in part on receiving an RAR for another UE (e.g., based at least in part on receiving, during an RAR window, an RAR that is associated with the other UE). Additionally, or alternatively, the capability information may indicate UE support for performing a random access procedure (e.g., a RACH procedure) using an over-provisioned CS scheme, such as the over-provisioned CS scheme described above in connection with FIG. 3D, among other examples.

As shown by reference number 404, the network node 110 may transmit, and the UE 120 may receive, configuration information. In some aspects, the UE 120 may receive the configuration information via one or more of system information signaling (e.g., a master information block (MIB) or a SIB, among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC-CEs or one or more DCI messages, among other examples.

In some aspects, the configuration information may include an indication of a selection of one or more configuration parameters (e.g., a selection of the one or more configuration parameters already known to the UE 120 or previously indicated by the network node or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate a random access configuration, such as the random access configuration described above in connection with reference number 305, among other examples. Additionally, or alternatively, the configuration information may indicate one or more candidate root sequences to be used by the UE 120 for a PRACH transmission (e.g., a preamble or msg1) or one or more CSs associated with each candidate root sequence. In some aspects, the configuration information may indicate that the UE 120 is to operate based at least in part on an over-provisioned CS scheme (e.g., a scheme in which the UE 120 selects from a higher number of CSs within a given root sequence than for traditional random access procedures, with the difference between CSs being smaller than a maximum RTT, as described above in connection with FIG. 3D), among other examples.

Additionally, or alternatively, the configuration information may indicate an RAR window associated with the UE 120, such as via an ra-ResponseWindow IE, among other examples. Moreover, in some aspects the configuration information may include an indication of an RRC window extension associated with the RAR window. For example, the UE 120 may receive an indication of the RAR window extension via an IE in an RRC message, among other examples. As described in more detail below in connection with reference number 410, the RAR window extension may be a period of time that is used to extend a default RAR response window (e.g., ra-ResponseWindow) under certain conditions. In some other aspects, the RAR window extension may be received via different signaling, such as via an RAR (as described in more detail below in connection with reference number 408). Moreover, the configuration information may indicate a CS threshold associated with the RAR window extension, which is described in more detail below in connection with reference number 410.

The UE 120 may configure itself based at least in part on the configuration information. In some aspects, the UE 120 may be configured to perform one or more operations described herein based at least in part on the configuration information.

As indicated by reference number 406, the UE 120 may transmit, and the network node 110 may receive, a PRACH message (e.g., msg1) that is based at least in part on a selected root sequence and a selected CS associated with the selected root sequence. Moreover, in a similar manner as described above in connection with FIGS. 3A-3D, the network node 110 may also receive PRACH messages from other UEs (not shown in FIG. 4A) that may collide with the PRACH message shown in connection with reference number 406. In some aspects, however, such as aspects involving an over-provisioned CS scheme, there may be a low likelihood that another UE selects a same CS within the root sequence selected by the UE 120, as described above in connection with FIG. 3D. In that way, if the network node 110 receives the PRACH message shown by reference number 406 and a PRACH communication from one or more other UEs, the multiple PRACH messages may be associated with different CSs, even if two or more of the PRACH messages are associated with the same root sequence.

As indicated by reference number 408, the network node 110 may transmit, and the UE 120 may receive, an RAR (e.g., msg2) that is associated with the root sequence selected by the UE 120 but that is associated with a CS that is different from the CS selected by the UE 120. Put another way, the UE 120 may receive a msg2 that is intended for a different UE. In some aspects, the msg2 may be transmitted through DCI and may include a cyclic redundancy check (CRC) scrambled by a random access radio network temporary identifier (RA-RNTI). In this way, all UEs that transmitted in the same RO (e.g., all UEs that transmitted a PRACH message in the same RO) may receive and decode the common msg2. In this aspect, upon decoding the RAR shown in connection with reference number 408, the UE 120 may determine that the RAR is intended for a different UE, or may determine that the RAR is associated with the same root sequence selected by the UE 120 but with a different CS than the CS selected by the UE 120. Accordingly, the UE 120 may determine that the RAR window may need to be adjusted (e.g., extended) in order to safely receive a sequential RAR that is intended for the UE 120.

As described above in connection with reference number 404, in some aspects the configuration information (e.g., RRC signaling) may include an indication of the RAR window extension; in some other aspects, an RAR or other dynamic signaling may include an indication of the RAR window extension. In aspects in which an RAR indicates the RAR window extension, the RAR shown in connection with reference number 408 may further indicate the RAR window extension. Put another way, in some aspects the network node 110 may indicate the RAR extension window dynamically through a msg2 transmission (e.g., the RAR shown in connection with reference number 408), such that UEs receiving the msg2 may be indicated with a corresponding RAR window extension to be applied for monitoring for sequential RARs. In some aspects, the network node 110 may indicate the RAR extension window for each msg2 transmission, because the quantity of sequential RAR transmissions may differ among RACH procedures (e.g., a duration of the RAR extension window may correspond to a quantity of sequential RARs to be transmitted by the network node 110, among other examples).

As indicated by reference number 410, based at least in part on receiving the RAR described above in connection with reference number 408 (e.g., based at least in part on receiving an RAR associated with a same root sequence as selected by the UE 120 but a different CS than the CS selected by the UE 120, among other examples), the UE 120 may perform an adjustment of the RAR window using the RAR window extension, resulting in an adjusted RAR window. In some aspects, the RAR window extension may correspond to a period of time to which an RAR window timer is to be set when the RAR window is adjusted. In such aspects, performing the adjustment of the RAR window using the RAR window extension may include resetting the RAR window based at least in part on the RAR window extension (e.g., setting the RAR window timer to a period of time corresponding to the RAR extension window). In some other aspects, the RAR window extension may correspond to a period of time to be added to the RAR window timer when the RAR window is to be adjusted. In such aspects, performing the adjustment of the RAR window using the RAR window extension may include extending the RAR window based at least in part on the RAR window extension (e.g., adding a period of time corresponding to the RAR extension window to the RAR window timer).

In some aspects, the UE 120 may only adjust the RAR window if a CS associated with the received RAR (e.g., the RAR shown in connection with reference number 408) is within a threshold of the CS selected by the UE 120. More particularly, in a similar manner as described above in connection with FIG. 3D, the network node 110 may only need to transmit sequential RARs (e.g., sequential msg2s) for UEs that selected CSs that are relatively close together, because such CSs may result in a collision from the network node 110's perspective. For CSs that are relatively far apart, the network node 110 may be able to identify the respective paths of the various UEs and thus may not implement sequential RARs (and thus there may be no need to extend the RAR window). Accordingly, in some aspects the UE 120 may be configured (e.g., via the configuration described above in connection with reference number 404) with a CS threshold, and thus performing the adjustment of the RAR window using the RAR window extension may be based at least in part on detecting that the difference between the CS in the RAR and the CS selected by the UE 120 satisfies the CS threshold.

Although only one RAR intended for a different UE (e.g., the RAR described in connection with reference number 408) and only one RAR window adjustment (e.g., the adjustment described in connection with reference number 410) are shown in FIG. 4A for ease of description, in some other aspects the UE 120 may receive multiple RARs that are intended for other UEs (e.g., multiple RARs that include a same root sequence as selected by the UE 120 but a different CS) and thus the UE 120 may perform multiple adjustments of the RAR window, one for each RAR received. Put another way, in some aspects the network node 110 may transmit, and the UE 120 may receive, during the adjusted RAR window, another RAR that is associated with the root sequence selected by the UE 120 and another CS that is different from the CS selected by the UE 120. In such aspects, the UE 120 may perform an adjustment of the adjusted RAR window using the RAR window extension, such as by resetting the adjusted RAR window to the RAR window extension or else extending the adjusted RAR window by the RAR window extension, among other examples.

As indicated by reference number 412, the network node 110 and the UE 120 may communicate based at least in part on the adjusted RAR window. For example, the network node 110 and the UE 120 may communicate via an additional RAR (e.g., msg2 or msgX), a message transmitted in response to an additional RAR (e.g., msg3 or msgY), an additional PRACH message (e.g., msg1), or a similar communication. More particularly, reference number 414 indicates various scenarios associated with the network node 110 and the UE 120 communicating based at least in part on the RAR window or the adjusted RAR window. As shown by reference number 414, in aspects in which the UE 120 receives a msg2 for the CS selected by the UE 120 within the RAR window, the UE 120 may proceed with the RACH procedure by transmitting msg3 (which is described in more detail below in connection with FIG. 4B). Moreover, as further shown by reference number 414, in aspects in which the UE 120 does not receive a msg2 for the CS selected by the UE 120 within the RAR window but instead receives a msgX for the CS selected by the UE 120 within the RAR window, the UE 120 may proceed with the RACH procedure by transmitting msgY (which is described in more detail below in connection with FIG. 4D). Moreover, as further shown by reference number 414, in aspects in which the UE 120 does not receive a msg2 or a msgX for the CS selected by the UE 120 within the RAR window but does receive a msg2 for the root sequence selected by the UE 120 within the RAR window, the UE 120 may adjust the RAR window as described above in connection with reference number 410 (which is further described in more detail below in connection with FIG. 4C). Moreover, as further shown by reference number 414, in aspects in which the UE 120 does not receive a msg2 or a msgX for the CS selected by the UE 120 within the RAR window and also does not receive a msg2 for the root sequence selected by the UE 120 within the RAR window, the UE 120 may need to retry the RACH procedure in the next RO, such as by retransmitting msg1 (which is described in more detail below in connection with FIG. 4E).

More particularly, as shown by example 416 in FIG. 4B, in some aspects the UE 120 may transmit, and the network node 110 may receive, a PRACH message (which may be substantially similar to the PRACH message described above in connection with reference number 406), as indicated by reference number 417. As indicated by reference number 418, in this aspect the network node 110 may transmit, and the UE 120 may receive, an RAR (e.g., msg2) that is associated with the root sequence and the CS selected by the UE 120 and that is received within an RAR window 420 associated with the UE 120. Accordingly, the UE 120 may proceed with the RACH procedure, such as by transmitting msg3 using resources indicated by the RAR, as indicated by reference number 422.

In some other aspects, however, an RAR intended for the UE 120 may not be received within the RAR window 420, and thus the UE 120 may need to adjust the RAR window to wait for a sequential RAR, in a similar manner as described above in connection with FIG. 4A. More particularly, as shown by example 424 in FIG. 4C, the UE 120 may transmit, and the network node 110 may receive, a first PRACH message (which may be substantially similar to the PRACH message described above in connection with reference number 406), as indicated by reference number 425. Moreover, the network node 110 may transmit, and the UE 120 may receive, a first RAR received within the RAR window 420, as indicated by reference number 426. In a similar manner as described above in connection with reference number 408, in this aspect the first RAR may be associated with a same root sequence as the root sequence selected by the UE 120 but with a different CS (e.g., the first RAR may be associated with a CS that is within a CS threshold of the CS selected by the UE 120, among other examples). Accordingly, the UE 120 may adjust the RAR window 420 based at least in part on an RAR window extension 428, in a similar manner as described above in connection with reference number 410. Put another way, based at least in part on the UE 120 receiving an RAR (e.g., msg2) that does not indicate msg3 resources corresponding to the UE 120's transmitted CS but that does indicate msg3 resources for at least one other transmitted CS from the same root sequence, the UE 120 may detect that a sequential msg2 transmission is forthcoming, and thus the UE 120 may adjust the RAR window 420 based at least in part on the RAR window extension 428 and continue to monitor for msg2.

During the RAR window extension 428, if the UE 120 decodes either msg2 or msgX corresponding to the CS selected by the UE 120, then the UE 120 may proceed with transmission of msg3 or msgY, accordingly. For example, as indicated by reference number 430, the network node 110 may transmit, and the UE 120 may receive during the RAR window extension 428, a second RAR (e.g., a msg2 or msgX) associated with the root sequence selected by the UE 120 and the CS selected by the UE 120. In such aspects, the UE 120 may transmit (e.g., using resources indicated by the second RAR), and the network node 110 may receive, at least one of a data message (e.g., msg3) or another PRACH message (e.g., msgX), as indicated by reference number 432, among other examples.

However, in aspects in which the UE 120 does not receive either msg2 or msgX within the RAR window extension 428, the UE 120 may proceed with a msg1 retransmission (e.g., a second PRACH message) in the next PRACH interval (e.g., RO), as indicated by reference number 434. In such aspects, the second PRACH message may be transmitted using a transmit power that is higher than a transmit power used for the first PRACH message described above in connection with reference number 425 in order to increase a likelihood of safe reception of the second PRACH message by the network node 110. Put another way, in some aspects the UE 120 may detect, prior to the UE receiving a second RAR that is associated with the selected CS, that the adjusted RAR window has elapsed, and thus the UE 120 may transmit a second PRACH message that is associated with a transmit power that is higher than a transmit power associated with the first PRACH message.

As shown by example 436 in FIG. 4D, if the UE 120 receives a msgX within an RAR window that is directed to the UE 120, the UE 120 may forgo extending the RAR window and instead transmit another PRACH message (e.g., msgY) using resources indicated by the msgX, in a similar manner as described above in connection with FIG. 3C. More particularly, as indicated by reference number 438, the UE 120 may transmit, and the network node 110 may receive, a PRACH message (which may be substantially similar to the PRACH message described above in connection with reference number 406). As indicated by reference number 440, the network node 110 may transmit, and the UE 120 may receive, an RAR within RAR window 420, which, in this aspect, may be a msgX associated with the UE 120. Accordingly, as indicated by reference number 442, the UE 120 may transmit, and the network node 110 may receive, another PRACH message (e.g., msgY) using the resources indicated by the msgX transmission, and thus the RACH procedure may proceed in a substantially similar manner as described above in connection with FIG. 3C.

As shown by example 444 in FIG. 4E, in aspects in which the UE 120 receives no RARs (e.g., msg2 or msgX) within the RAR window 420, receives a msg2 within the RAR window 420 but with no msg3 resources allocated to the root sequence selected by the UE 120, or receives a msgX within the RAR window 420 but with no msgY resources allocated to the root sequence selected by the UE 120, the UE 120 may simply retry the RACH procedure, such as by retransmitting a PRACH message (e.g., msg1) in the next RO. More particularly, as indicated by reference number 446, the UE 120 may transmit, and the network node 110 may receive, a first PRACH message (which may be substantially similar to the PRACH message described above in connection with reference number 406). In this example, the UE 120 receives no RAR associated with the root sequence selected by the UE 120 prior to the RAR window elapsing. Accordingly, as indicated by reference number 448, the UE 120 may retry the RACH procedure during a subsequent RO, such as by transmitting a second RACH message (which also may be substantially similar to the PRACH message described above in connection with reference number 406). In some aspects, a transmit power associated with the second PRACH message may be higher than a transmit power associated with the first PRACH message, such as for a purpose of increasing a likelihood that the network node 110 safely receives the second PRACH message.

Based at least in part on the UE 120 adjusting an RAR window when the UE 120 receives an RAR associated with a root sequence transmitted by the UE 120 but with a CS that is different from a CS transmitted by the UE 120, the UE 120 or the network node 110 may conserve computing, power, network, or communication resources that may have otherwise been consumed using traditional RACH procedures. For example, based at least in part on the UE 120 adjusting an RAR window when the UE 120 receives an RAR associated with a root sequence transmitted by the UE 120 but with a CS that is different from a CS transmitted by the UE 120, the UE 120 and the network node 110 may successfully complete RACH procedures associated with sequential RAR transmissions prior to an RAR window expiring at the UE 120, which may conserve computing, power, network, or communication resources that may have otherwise been consumed to perform additional RACH procedures in response to the RAR window expiring prior to the UE 120 receiving a sequential RAR.

As indicated above, FIGS. 4A-4E are provided as examples. Other examples may differ from what is described with respect to FIGS. 4A-4E.

FIG. 5 is a diagram illustrating an example process 500 performed, for example, at a UE or an apparatus of a UE. Example process 500 is an example where the apparatus or the UE (e.g., UE 120) performs operations associated with an RAR window extension for sequential RAR messages.

As shown in FIG. 5, in some aspects, process 500 may include receiving an indication of an RAR window extension (block 510). For example, the UE (e.g., using reception component 702 or communication manager 706, depicted in FIG. 7) may receive an indication of an RAR window extension, as described above.

As further shown in FIG. 5, in some aspects, process 500 may include transmitting a first PRACH message that is based at least in part on a selected root sequence and a selected CS associated with the selected root sequence (block 520). For example, the UE (e.g., using transmission component 704 or communication manager 706, depicted in FIG. 7) may transmit a first PRACH message that is based at least in part on a selected root sequence and a selected CS associated with the selected root sequence, as described above.

As further shown in FIG. 5, in some aspects, process 500 may include receiving, during an RAR window, a first RAR that is associated with the selected root sequence and a first CS that is different from the selected CS (block 530). For example, the UE (e.g., using reception component 702 or communication manager 706, depicted in FIG. 7) may receive, during an RAR window, a first RAR that is associated with the selected root sequence and a first CS that is different from the selected CS, as described above.

As further shown in FIG. 5, in some aspects, process 500 may include performing, based at least in part on receiving the first RAR, an adjustment of the RAR window using the RAR window extension, resulting in an adjusted RAR window (block 540). For example, the UE (e.g., using communication manager 706, depicted in FIG. 7) may perform, based at least in part on receiving the first RAR, an adjustment of the RAR window using the RAR window extension, resulting in an adjusted RAR window, as described above.

As further shown in FIG. 5, in some aspects, process 500 may include communicating based at least in part on the adjusted RAR window (block 550). For example, the UE (e.g., using reception component 702, transmission component 704, or communication manager 706, depicted in FIG. 7) may communicate based at least in part on the adjusted RAR window, as described above.

Process 500 may include additional aspects, such as any single aspect or any combination of aspects described below or in connection with one or more other processes described elsewhere herein.

In a first aspect, process 500 includes detecting that a difference between the first CS and the selected CS satisfies a CS threshold, wherein performing the adjustment of the RAR window using the RAR window extension is based at least in part on detecting that the difference between the first CS and the selected CS satisfies the CS threshold.

In a second aspect, alone or in combination with the first aspect, receiving the indication of the RAR window extension includes receiving the indication of the RAR window extension via a radio resource control message.

In a third aspect, alone or in combination with one or more of the first and second aspects, performing the adjustment of the RAR window using the RAR window extension includes one of resetting the RAR window based at least in part on the RAR window extension, or extending the RAR window based at least in part on the RAR window extension.

In a fourth aspect, alone or in combination with one or more of the first through third aspects, communicating based at least in part on the adjusted RAR window includes receiving, during the adjusted RAR window, a second RAR that is associated with the selected root sequence and a second CS that is different from the selected CS, and process 500 includes performing an adjustment of the adjusted RAR window using the RAR window extension based at least in part on receiving the second RAR.

In a fifth aspect, alone or in combination with one or more of the first through fourth aspects, receiving the indication of the RAR window extension includes receiving the indication of the RAR window extension via the first RAR.

In a sixth aspect, alone or in combination with one or more of the first through fifth aspects, communicating based at least in part on the adjusted RAR window includes receiving, during the adjusted RAR window, a second RAR that is associated with the selected CS, and transmitting, using resources indicated by the second RAR, at least one of a data message or a second PRACH message.

In a seventh aspect, alone or in combination with one or more of the first through sixth aspects, process 500 includes detecting, prior to the UE receiving a second RAR that is associated with the selected CS, that the adjusted RAR window has elapsed, wherein communicating based at least in part on the adjusted RAR window includes transmitting a second PRACH message based at least in part on detecting that the adjusted RAR window has elapsed, and wherein a first transmit power associated with the first PRACH message is lower than a second transmit power associated with the second PRACH message.

In an eighth aspect, alone or in combination with one or more of the first through seventh aspects, communicating based at least in part on the adjusted RAR window includes receiving, during the adjusted RAR window, a second RAR that is associated with the selected CS and that omits allocation of resources for another message to be transmitted by the UE, and transmitting a second PRACH message based at least in part on the second RAR omitting allocation of resources for the other message, wherein a first transmit power associated with the first PRACH message is lower than a second transmit power associated with the second PRACH message.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node. Example process 600 is an example where the apparatus or the network node (e.g., network node 110) performs operations associated with an RAR window extension for sequential RAR messages.

As shown in FIG. 6, in some aspects, process 600 may include transmitting, to a UE, an indication of an RAR window extension (block 610). For example, the network node (e.g., using transmission component 804 or communication manager 806, depicted in FIG. 8) may transmit, to a UE, an indication of an RAR window extension, as described above.

As further shown in FIG. 6, in some aspects, process 600 may include receiving, from the UE, a first PRACH message that is based at least in part on a selected root sequence and a selected CS associated with the selected root sequence (block 620). For example, the network node (e.g., using reception component 802 or communication manager 806, depicted in FIG. 8) may receive, from the UE, a first PRACH message that is based at least in part on a selected root sequence and a selected CS associated with the selected root sequence, as described above.

As further shown in FIG. 6, in some aspects, process 600 may include transmitting, to the UE during an RAR window, a first RAR that is associated with the selected root sequence and a first CS that is different from the selected CS, wherein an RAR window associated with the UE is adjusted using the RAR window extension, resulting in an adjusted RAR window, based at least in part on the first RAR being associated with the selected root sequence and the first CS (block 630). For example, the network node (e.g., using transmission component 804 or communication manager 806, depicted in FIG. 8) may transmit, to the UE during an RAR window, a first RAR that is associated with the selected root sequence and a first CS that is different from the selected CS, wherein an RAR window associated with the UE is adjusted using the RAR window extension, resulting in an adjusted RAR window, based at least in part on the first RAR being associated with the selected root sequence and the first CS, as described above.

As further shown in FIG. 6, in some aspects, process 600 may include communicating, with the UE, based at least in part on the adjusted RAR window (block 640). For example, the network node (e.g., using reception component 802, transmission component 804, or communication manager 806, depicted in FIG. 8) may communicate, with the UE, based at least in part on the adjusted RAR window, as described above.

Process 600 may include additional aspects, such as any single aspect or any combination of aspects described below or in connection with one or more other processes described elsewhere herein.

In a first aspect, the RAR window is adjusted using the RAR window extension based at least in part on a difference between the first CS and the selected CS satisfying a CS threshold.

In a second aspect, alone or in combination with the first aspect, transmitting the indication of the RAR window extension includes transmitting the indication of the RAR window extension via a radio resource control message.

In a third aspect, alone or in combination with one or more of the first and second aspects, the RAR window is adjusted using the RAR window extension based at least in part on at least one of resetting the RAR window based at least in part on the RAR window extension, or extending the RAR window based at least in part on the RAR window extension.

In a fourth aspect, alone or in combination with one or more of the first through third aspects, communicating based at least in part on the adjusted RAR window includes transmitting, to the UE during the adjusted RAR window, a second RAR that is associated with the selected root sequence and a second CS that is different from the selected CS, wherein the adjusted RAR window is adjusted using the RAR window extension based at least in part on the second RAR being associated with the selected root sequence and the second CS.

In a fifth aspect, alone or in combination with one or more of the first through fourth aspects, transmitting the indication of the RAR window extension includes transmitting the indication of the RAR window extension via the first RAR.

In a sixth aspect, alone or in combination with one or more of the first through fifth aspects, communicating based at least in part on the adjusted RAR window includes transmitting, to the UE during the adjusted RAR window, a second RAR that is associated with the selected CS, and receiving, from the UE, at least one of a data message or a second PRACH message using resources indicated by the second RAR.

In a seventh aspect, alone or in combination with one or more of the first through sixth aspects, communicating based at least in part on the adjusted RAR window includes receiving, from the UE, a second PRACH message based at least in part on the adjusted RAR window elapsing prior to transmission of a second RAR that is associated with the selected CS, wherein a first transmit power associated with the first PRACH message is lower than a second transmit power associated with the second PRACH message.

In an eighth aspect, alone or in combination with one or more of the first through seventh aspects, communicating based at least in part on the adjusted RAR window includes transmitting, to the UE during the adjusted RAR window, a second RAR that is associated with the selected CS and that omits allocation of resources for another message to be transmitted by the UE, and receiving, from the UE, a second PRACH message based at least in part on the second RAR omitting allocation of resources for the other message, wherein a first transmit power associated with the first PRACH message is lower than a second transmit power associated with the second PRACH message.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 4A-4E. Additionally, or alternatively, the apparatus 700 may be configured to perform one or more processes described herein, such as process 500 of FIG. 5. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive an indication of an RAR window extension. The transmission component 704 may transmit a first PRACH message that is based at least in part on a selected root sequence and a selected CS associated with the selected root sequence. The reception component 702 may receive, during an RAR window, a first RAR that is associated with the selected root sequence and a first CS that is different from the selected CS. The communication manager 706 may perform, based at least in part on receiving the first RAR, an adjustment of the RAR window using the RAR window extension, resulting in an adjusted RAR window. The reception component 702 or the transmission component 704 may communicate based at least in part on the adjusted RAR window.

The communication manager 706 may detect that a difference between the first CS and the selected CS satisfies a CS threshold, wherein performing the adjustment of the RAR window using the RAR window extension is based at least in part on detecting that the difference between the first CS and the selected CS satisfies the CS threshold.

The communication manager 706 may detect, prior to the UE receiving a second RAR that is associated with the selected CS, that the adjusted RAR window has elapsed, wherein communicating based at least in part on the adjusted RAR window includes transmitting a second PRACH message based at least in part on detecting that the adjusted RAR window has elapsed, and wherein a first transmit power associated with the first PRACH message is lower than a second transmit power associated with the second PRACH message.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of another example apparatus 800 for wireless communication. The apparatus 800 may be a network node, or a network node may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 4A-4E. Additionally, or alternatively, the apparatus 800 may be configured to perform one or more processes described herein, such as process 600 of FIG. 6. In some aspects, the apparatus 800 or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 or the transmission component 804 may include or may be included in a network interface. The network interface may be configured to obtain or output signals for the apparatus 800 via one or more communications links, such as a backhaul link, a midhaul link, or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The transmission component 804 may transmit, to a UE, an indication of an RAR window extension. The reception component 802 may receive, from the UE, a first PRACH message that is based at least in part on a selected root sequence and a selected CS associated with the selected root sequence. The transmission component 804 may transmit, to the UE during an RAR window, a first RAR that is associated with the selected root sequence and a first CS that is different from the selected CS, wherein an RAR window associated with the UE is adjusted using the RAR window extension, resulting in an adjusted RAR window, based at least in part on the first RAR being associated with the selected root sequence and the first CS. The reception component 802 or the transmission component 804 may communicate, with the UE, based at least in part on the adjusted RAR window.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving an indication of a random access response (RAR) window extension; transmitting a first physical random access channel (PRACH) message that is based at least in part on a selected root sequence and a selected cyclic shift (CS) associated with the selected root sequence; receiving, during an RAR window, a first RAR that is associated with the selected root sequence and a first CS that is different from the selected CS; performing, based at least in part on receiving the first RAR, an adjustment of the RAR window using the RAR window extension, resulting in an adjusted RAR window; and communicating based at least in part on the adjusted RAR window.

Aspect 2: The method of Aspect 1, further comprising detecting that a difference between the first CS and the selected CS satisfies a CS threshold, wherein performing the adjustment of the RAR window using the RAR window extension is based at least in part on detecting that the difference between the first CS and the selected CS satisfies the CS threshold.

Aspect 3: The method of any of Aspects 1-2, wherein receiving the indication of the RAR window extension includes receiving the indication of the RAR window extension via a radio resource control message.

Aspect 4: The method of any of Aspects 1-3, wherein performing the adjustment of the RAR window using the RAR window extension includes one of: resetting the RAR window based at least in part on the RAR window extension, or extending the RAR window based at least in part on the RAR window extension.

Aspect 5: The method of any of Aspects 1-4, wherein communicating based at least in part on the adjusted RAR window includes receiving, during the adjusted RAR window, a second RAR that is associated with the selected root sequence and a second CS that is different from the selected CS, and wherein the method further comprises performing an adjustment of the adjusted RAR window using the RAR window extension based at least in part on receiving the second RAR.

Aspect 6: The method of any of Aspects 1-5, wherein receiving the indication of the RAR window extension includes receiving the indication of the RAR window extension via the first RAR.

Aspect 7: The method of any of Aspects 1-6, wherein communicating based at least in part on the adjusted RAR window includes: receiving, during the adjusted RAR window, a second RAR that is associated with the selected CS, and transmitting, using resources indicated by the second RAR, at least one of a data message or a second PRACH message.

Aspect 8: The method of any of Aspects 1-7, further comprising detecting, prior to the UE receiving a second RAR that is associated with the selected CS, that the adjusted RAR window has elapsed, wherein communicating based at least in part on the adjusted RAR window includes transmitting a second PRACH message based at least in part on detecting that the adjusted RAR window has elapsed, and wherein a first transmit power associated with the first PRACH message is lower than a second transmit power associated with the second PRACH message.

Aspect 9: The method of any of Aspects 1-8, wherein communicating based at least in part on the adjusted RAR window includes: receiving, during the adjusted RAR window, a second RAR that is associated with the selected CS and that omits allocation of resources for another message to be transmitted by the UE, and transmitting a second PRACH message based at least in part on the second RAR omitting allocation of resources for the other message, wherein a first transmit power associated with the first PRACH message is lower than a second transmit power associated with the second PRACH message.

Aspect 10: A method of wireless communication performed by a network node, comprising: transmitting, to a user equipment (UE), an indication of a random access response (RAR) window extension; receiving, from the UE, a first physical random access channel (PRACH) message that is based at least in part on a selected root sequence and a selected cyclic shift (CS) associated with the selected root sequence; transmitting, to the UE during an RAR window, a first RAR that is associated with the selected root sequence and a first CS that is different from the selected CS, wherein an RAR window associated with the UE is adjusted using the RAR window extension, resulting in an adjusted RAR window, based at least in part on the first RAR being associated with the selected root sequence and the first CS; and communicating, with the UE, based at least in part on the adjusted RAR window.

Aspect 11: The method of Aspect 10, wherein the RAR window is adjusted using the RAR window extension based at least in part on a difference between the first CS and the selected CS satisfying a CS threshold.

Aspect 12: The method of any of Aspects 10-11, wherein transmitting the indication of the RAR window extension includes transmitting the indication of the RAR window extension via a radio resource control message.

Aspect 13: The method of any of Aspects 10-12, wherein the RAR window is adjusted using the RAR window extension based at least in part on at least one of: resetting the RAR window based at least in part on the RAR window extension, or extending the RAR window based at least in part on the RAR window extension.

Aspect 14: The method of any of Aspects 10-13, wherein communicating based at least in part on the adjusted RAR window includes transmitting, to the UE during the adjusted RAR window, a second RAR that is associated with the selected root sequence and a second CS that is different from the selected CS, wherein the adjusted RAR window is adjusted using the RAR window extension based at least in part on the second RAR being associated with the selected root sequence and the second CS.

Aspect 15: The method of any of Aspects 10-14, wherein transmitting the indication of the RAR window extension includes transmitting the indication of the RAR window extension via the first RAR.

Aspect 16: The method of any of Aspects 10-15, wherein communicating based at least in part on the adjusted RAR window includes: transmitting, to the UE during the adjusted RAR window, a second RAR that is associated with the selected CS, and receiving, from the UE, at least one of a data message or a second PRACH message using resources indicated by the second RAR.

Aspect 17: The method of any of Aspects 10-16, wherein communicating based at least in part on the adjusted RAR window includes receiving, from the UE, a second PRACH message based at least in part on the adjusted RAR window elapsing prior to transmission of a second RAR that is associated with the selected CS, and wherein a first transmit power associated with the first PRACH message is lower than a second transmit power associated with the second PRACH message.

Aspect 18: The method of any of Aspects 10-17, wherein communicating based at least in part on the adjusted RAR window includes: transmitting, to the UE during the adjusted RAR window, a second RAR that is associated with the selected CS and that omits allocation of resources for another message to be transmitted by the UE, and receiving, from the UE, a second PRACH message based at least in part on the second RAR omitting allocation of resources for the other message, wherein a first transmit power associated with the first PRACH message is lower than a second transmit power associated with the second PRACH message.

Aspect 19: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-18.

Aspect 20: An apparatus for wireless communication at a device, the apparatus comprising one or more memories and one or more processors coupled to the one or more memories, the one or more processors configured to cause the device to perform the method of one or more of Aspects 1-18.
Aspect 21: An apparatus for wireless communication, the apparatus comprising at least one means for performing the method of one or more of Aspects 1-18.

Aspect 22: A non-transitory computer-readable medium storing code for wireless communication, the code comprising instructions executable by one or more processors to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

Aspect 24: A device for wireless communication, the device comprising a processing system that includes one or more processors and one or more memories coupled with the one or more processors, the processing system configured to cause the device to perform the method of one or more of Aspects 1-18.

Aspect 25: An apparatus for wireless communication at a device, the apparatus comprising one or more memories and one or more processors coupled to the one or more memories, the one or more processors individually or collectively configured to cause the device to perform the method of one or more of Aspects 1-18.

Aspect 26: A device comprising a processing system that includes one or more processors and one or more code-storing memories coupled with the one or more processors, the processing system configured to cause the device to perform the method of one or more of Aspects 1-18.

Aspect 27: A device comprising a processing system that includes processor circuitry and code-storing memory circuitry, the processing system configured to cause the device to perform the method of one or more of Aspects 1-18.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive an indication of a random access response (RAR) window extension;
transmit a first physical random access channel (PRACH) message that is based at least in part on a selected root sequence and a selected cyclic shift (CS) associated with the selected root sequence;
receive, during an RAR window, a first RAR that is associated with the selected root sequence and a first CS that is different from the selected CS;
perform, based at least in part on receiving the first RAR, an adjustment of the RAR window using the RAR window extension, resulting in an adjusted RAR window; and
communicate based at least in part on the adjusted RAR window.

2. The UE of claim 1, wherein the processing system is configured to cause the UE to detect that a difference between the first CS and the selected CS satisfies a CS threshold, wherein the processing system, to cause the UE to perform the adjustment of the RAR window using the RAR window extension, is configured to cause the UE to perform the adjustment of the RAR window using the RAR window extension based at least in part on detecting that the difference between the first CS and the selected CS satisfies the CS threshold.

3. The UE of claim 1, wherein the processing system, to cause the UE to receive the indication of the RAR window extension, is configured to cause the UE to receive the indication of the RAR window extension via a radio resource control message.

4. The UE of claim 1, wherein the processing system, to cause the UE to perform the adjustment of the RAR window using the RAR window extension, is configured to cause the UE to one of:
reset the RAR window based at least in part on the RAR window extension, or
extend the RAR window based at least in part on the RAR window extension.

5. The UE of claim 1, wherein the processing system, to cause the UE to communicate based at least in part on the adjusted RAR window, is configured to cause the UE to receive, during the adjusted RAR window, a second RAR that is associated with the selected root sequence and a second CS that is different from the selected CS, and
wherein the processing system is configured to cause the UE to perform an adjustment of the adjusted RAR window using the RAR window extension based at least in part on receiving the second RAR.

6. The UE of claim 1, wherein the processing system, to cause the UE to receive the indication of the RAR window extension, is configured to cause the UE to receive the indication of the RAR window extension via the first RAR.

7. The UE of claim 1, wherein the processing system, to cause the UE to communicate based at least in part on the adjusted RAR window, is configured to cause the UE to:
receive, during the adjusted RAR window, a second RAR that is associated with the selected CS, and
transmit, using resources indicated by the second RAR, at least one of a data message or a second PRACH message.

8. The UE of claim 1, wherein the processing system is configured to cause the UE to detect, prior to the UE receiving a second RAR that is associated with the selected CS, that the adjusted RAR window has elapsed,
wherein the processing system, to cause the UE to communicate based at least in part on the adjusted RAR window, is configured to cause the UE to transmit a second PRACH message based at least in part on detecting that the adjusted RAR window has elapsed, and
wherein a first transmit power associated with the first PRACH message is lower than a second transmit power associated with the second PRACH message.

9. The UE of claim 1, wherein the processing system, to cause the UE to communicate based at least in part on the adjusted RAR window, is configured to cause the UE to:
receive, during the adjusted RAR window, a second RAR that is associated with the selected CS and that omits allocation of resources for another message to be transmitted by the UE, and
transmit a second PRACH message based at least in part on the second RAR omitting allocation of resources for the other message,
wherein a first transmit power associated with the first PRACH message is lower than a second transmit power associated with the second PRACH message.

10. A network node, comprising:
a processing system that includes one or more processors and one or more code-storing memories coupled with the one or more processors, the processing system configured to cause the network node to:
transmit, to a user equipment (UE), an indication of a random access response (RAR) window extension;
receive, from the UE, a first physical random access channel (PRACH) message that is based at least in part on a selected root sequence and a selected cyclic shift (CS) associated with the selected root sequence;
transmit, to the UE during an RAR window, a first RAR that is associated with the selected root sequence and a first CS that is different from the selected CS,
wherein an RAR window associated with the UE is adjusted using the RAR window extension, resulting in an adjusted RAR window, based at least in part on the first RAR being associated with the selected root sequence and the first CS; and
communicate, with the UE, based at least in part on the adjusted RAR window.

11. The network node of claim 10, wherein the RAR window is adjusted using the RAR window extension based at least in part on a difference between the first CS and the selected CS satisfying a CS threshold.

12. The network node of claim 10, wherein the processing system, to cause the network node to transmit the indication of the RAR window extension, is configured to cause the network node to transmit the indication of the RAR window extension via a radio resource control message.

13. The network node of claim 10, wherein the RAR window is adjusted using the RAR window extension based at least in part on at least one of:
resetting the RAR window based at least in part on the RAR window extension, or
extending the RAR window based at least in part on the RAR window extension.

14. The network node of claim 10, wherein the processing system, to cause the network node to communicate based at least in part on the adjusted RAR window, is configured to cause the network node to transmit, to the UE during the adjusted RAR window, a second RAR that is associated with the selected root sequence and a second CS that is different from the selected CS,
wherein the adjusted RAR window is adjusted using the RAR window extension based at least in part on the second RAR being associated with the selected root sequence and the second CS.

15. The network node of claim 10, wherein the processing system, to cause the network node to transmit the indication of the RAR window extension, is configured to cause the network node to transmit the indication of the RAR window extension via the first RAR.

16. The network node of claim 10, wherein the processing system, to cause the network node to communicate based at least in part on the adjusted RAR window, is configured to cause the network node to:
transmit, to the UE during the adjusted RAR window, a second RAR that is associated with the selected CS, and
receive, from the UE, at least one of a data message or a second PRACH message using resources indicated by the second RAR.

17. The network node of claim 10, wherein the processing system, to cause the network node to communicate based at least in part on the adjusted RAR window, is configured to cause the network node to receive, from the UE, a second PRACH message based at least in part on the adjusted RAR window elapsing prior to transmission of a second RAR that is associated with the selected CS, and
wherein a first transmit power associated with the first PRACH message is lower than a second transmit power associated with the second PRACH message.

18. The network node of claim 10, wherein the processing system, to cause the network node to communicate based at least in part on the adjusted RAR window, is configured to cause the network node to:
transmit, to the UE during the adjusted RAR window, a second RAR that is associated with the selected CS and that omits allocation of resources for another message to be transmitted by the UE, and
receive, from the UE, a second PRACH message based at least in part on the second RAR omitting allocation of resources for the other message,
wherein a first transmit power associated with the first PRACH message is lower than a
second transmit power associated with the second PRACH message.

19. A method of wireless communication performed by a user equipment (UE), comprising:
receiving an indication of a random access response (RAR) window extension;
transmitting a first physical random access channel (PRACH) message that is based at least in part on a selected root sequence and a selected cyclic shift (CS) associated with the selected root sequence;
receiving, during an RAR window, a first RAR that is associated with the selected root sequence and a first CS that is different from the selected CS;
performing, based at least in part on receiving the first RAR, an adjustment of the RAR window using the RAR window extension, resulting in an adjusted RAR window; and
communicating based at least in part on the adjusted RAR window.

20. The method of claim 19, further comprising detecting that a difference between the first CS and the selected CS satisfies a CS threshold,
wherein performing the adjustment of the RAR window using the RAR window extension is based at least in part on detecting that the difference between the first CS and the selected CS satisfies the CS threshold.

21. The method of claim 19, wherein receiving the indication of the RAR window extension includes receiving the indication of the RAR window extension via a radio resource control message.

22. The method of claim 19, wherein performing the adjustment of the RAR window using the RAR window extension includes one of:
resetting the RAR window based at least in part on the RAR window extension, or
extending the RAR window based at least in part on the RAR window extension.

23. The method of claim 19, wherein communicating based at least in part on the adjusted RAR window includes receiving, during the adjusted RAR window, a second RAR that is associated with the selected root sequence and a second CS that is different from the selected CS, and
wherein the method further comprises performing an adjustment of the adjusted RAR window using the RAR window extension based at least in part on receiving the second RAR.

24. The method of claim 19, wherein receiving the indication of the RAR window extension includes receiving the indication of the RAR window extension via the first RAR.

25. The method of claim 19, wherein communicating based at least in part on the adjusted RAR window includes:
receiving, during the adjusted RAR window, a second RAR that is associated with the selected CS, and
transmitting, using resources indicated by the second RAR, at least one of a data message or a second PRACH message.

26. The method of claim 19, further comprising detecting, prior to the UE receiving a second RAR that is associated with the selected CS, that the adjusted RAR window has elapsed, wherein communicating based at least in part on the adjusted RAR window includes transmitting a second PRACH message based at least in part on detecting that the adjusted RAR window has elapsed, and
wherein a first transmit power associated with the first PRACH message is lower than a second transmit power associated with the second PRACH message.

27. The method of claim 19, wherein communicating based at least in part on the adjusted RAR window includes:
receiving, during the adjusted RAR window, a second RAR that is associated with the selected CS and that omits allocation of resources for another message to be transmitted by the UE, and
transmitting a second PRACH message based at least in part on the second RAR omitting allocation of resources for the other message,
wherein a first transmit power associated with the first PRACH message is lower than a second transmit power associated with the second PRACH message.

28. A method of wireless communication performed by a network node, comprising:
transmitting, to a user equipment (UE), an indication of a random access response (RAR) window extension;
receiving, from the UE, a first physical random access channel (PRACH) message that is based at least in part on a selected root sequence and a selected cyclic shift (CS) associated with the selected root sequence;
transmitting, to the UE during an RAR window, a first RAR that is associated with the selected root sequence and a first CS that is different from the selected CS,
wherein an RAR window associated with the UE is adjusted using the RAR window extension, resulting in an adjusted RAR window, based at least in part on the first RAR being associated with the selected root sequence and the first CS; and
communicating, with the UE, based at least in part on the adjusted RAR window.

29. The method of claim 28, wherein communicating based at least in part on the adjusted RAR window includes transmitting, to the UE during the adjusted RAR window, a second RAR that is associated with the selected root sequence and a second CS that is different from the selected CS,
wherein the adjusted RAR window is adjusted using the RAR window extension based at least in part on the second RAR being associated with the selected root sequence and the second CS.

30. The method of claim 28, wherein communicating based at least in part on the adjusted RAR window includes:
transmitting, to the UE during the adjusted RAR window, a second RAR that is associated with the selected CS, and
receiving, from the UE, at least one of a data message or a second PRACH message using resources indicated by the second RAR.
